(19) United States
(12) Patent Application Publication
(10) Pub. No.: US 2022/0253791 A1
(43) Pub. Date: Aug. 11, 2022

(54) SYSTEM AND METHOD FOR PRIVATIZED PARCEL DELIVERY

(71) Applicant: BlindPost, LLC, Irvine, CA (US)

(72) Inventors: Carolyn Ross Andrews, Newport Beach, CA (US); Ryan James Peck, Naples, CA (US)

(21) Appl. No.: 17/669,061

(22) Filed: Feb. 10, 2022

Related U.S. Application Data
(60) Provisional application No. 63/148,080, filed on Feb. 10, 2021.

(51) Int. Cl. G06Q 10/08; G06Q 30/00

(52) U.S. Cl. CPC G06Q 10/083; G06Q 30/016

(57) ABSTRACT

A system and method for secure parcel delivery and/or privatizing personal identifiable information that includes: recording an association between user information and a user information code, the user information including at least shipping address information; at an online marketplace, establishing an association of a user information code with a delivery order, the user information code used in place of a delivery address and/or personal identifiable information; and servicing an information request that includes the user information code, the servicing the information request comprising generating a packing label of a product using the shipping address information accessed with the user information code.

### CROSS-REFERENCE TO RELATED APPLICATIONS

This application claims the benefit of U.S. Provisional Application No. 63/148,080, filed on 10 Feb. 2021, which is incorporated in its entirety by this reference.

### TECHNICAL FIELD

This invention relates generally to the field of digital information systems, and more specifically to a new and useful system and method for managing private information.

### BACKGROUND

The threat to personal privacy is at an all-time high in the current digital world. Given the rise of remote work with increasing numbers of people working for and operating businesses from their homes, more people are forced to expose even more information when conducting business. In particular, a worker may have to disclose their private address or other personal identifiable information (PII) when conducting business. This can pose a major barrier to business communication as many may wish to not disclose such information. Similarly, businesses generally want to avoid collecting and maintaining PII data due to laws such as European General Data Protection Regulation (GDPR) and California Consumer Privacy Act (CCPA). In many business areas such as sales, an inability to communicate directly, such as through physical delivery of goods, materials, documents, and/or other items, can limit a company's ability to engage with customers and partners. For example, virtual events and marketing outreach initiatives are limited in ability to provide gifts, swag, samples, and/or other items when they must ask potential recipients to provide private information like their personal mailing address in order to deliver the items. Thus, there is a need in the digital information systems field to create a new and useful system and method for privatized parcel delivery. This invention provides such a new and useful system and method.

### BRIEF DESCRIPTION OF THE FIGURES

FIG. 1 is a schematic representation of one variation of a system.

FIG. 2 is a flowchart representation of a first method.

FIG. 3 is a flowchart representation of a method applied to parcel delivery.

FIGS. 4 and 5 are communication flow diagrams of exemplary implementations of the method.

FIG. 6 is a flowchart representation of sender supplying a user information code.

FIG. 7 is a flowchart representation of a recipient being messaged to generate a user information code.

FIG. 8 is a communication flow diagram of bulk handling of multiple user information codes.

FIG. 9 is a diagram illustrating processing a parcel detected to include a user information code.

FIGS. 10A and 10B are diagrams illustrating a variation where detected location of a client device is used in determining address information to be used in place of a user information code.

FIG. 11 is an exemplary system architecture that may be used in implementing the system and/or method.

### DESCRIPTION OF THE EMBODIMENTS

The following description of the embodiments of the invention is not intended to limit the invention to these embodiments but rather to enable a person skilled in the art to make and use this invention.

### 1. Overview

A system and method for privatized parcel delivery functions to employ a digitally managed information system in allowing a first party to deliver items to a second party while the second party, through the system and method, is able to limit exposure of their personal information. In particular, the system and method can be applied in enabling the physical delivery of goods to a recipient without the recipient exposing their address information to the sender.

The system and method can leverage a user information code as a mechanism by which personal information can be automatically collected and associated. The user information code can be a transferrable mechanism that can be used in place of personal data. The user information code may then be securely used for limited access such that distribution of the personal information can be contained and controlled. Furthermore, the system and method may enable user-managed (i.e., individual) control over personal and private information, which may function to put ownership and control in the hands of the users.

In particular, the system and method can serve as a unique technical solution to the challenging problem of securely and/or privately mailing and delivering physical items to individuals.

The system and method may be a particularly useful tool in the business setting. For example, virtual events, in-person conferences or events, marketing departments, companies wanting to offer promotions or free samples, and/or other business-related functions may use such a system to send gifts, swag, samples, and/or other types of goods to individuals while preserving personal privacy of the recipients. With this option, individuals can have items shipped to their personal residence without having to disclose their home address to a business. Similarly, businesses may avoid needing to collect and store PII, thereby reducing their liability and enabling them to comply with standards such as GDPR and CCPA.

The system and method can facilitate the assignment of a user information code to a recipient that can be used by another person or company that wants to send an item to the recipient. Furthermore, in some variations, a user can still retain a level of control over use of personal user information even after sharing a user information code. For example, a user could prevent a company from sending marketing material to their home by disabling the user information code. A user could create multiple user information codes to share in different situations (e.g., direct mail vs. gifts).

The system and method can be configured to enable e-commerce sites, shipping and delivery companies, fulfillment centers, postal services, and/or other parties to integrate with and support the use of user information codes as a new digitally managed addressing mechanism. The system and method provide innovations related to user interfaces and digital interactions for managing use of user information codes, automated processing of orders associated with user information codes, and/or other aspects related to the user information codes.

Herein, the system and method are primarily described as it applies to securing address information when used for physically sending items from one party to another party. In particular, it is described as ordering one or more items to be delivered to a recipient. The system and method however are not limited to purchase orders or other forms of object delivery and could similarly be used for sending letters, marketing materials, or other forms of parcel communications.

The system and method may additionally or alternatively be extended to securing, managing, and/or sharing in a private and secure way other forms of personal information such as communication addresses (e.g., emails, phone numbers, etc.), identification information, health data, financial data (e.g., credit card information, account information, etc.), and/or other suitable types of information, data, or media of a user.

The system and method can be implemented and adapted to a variety of configurations depending on the involved parties and their form of integration. The system and method are preferably performed by a specially configured computer system that is operated by an “operating party”, which can be a single party but may additionally or alternatively involve cooperation between computer systems and devices managed by multiple parties.

In one exemplary implementation involving a fulfillment service, the system and method can involve three parties that interface with different aspects of implementing a computer system. A first party (i.e., the “sender”) is characterized as the entity attempting to deliver some item to a second party. The second party (i.e., the “receiver”) will generally be the user possessing the sensitive information (e.g., a delivery address) and in the case of a delivery implementation may be the recipient of the item. A third party (e.g., a fulfillment center, a third-party logistics partner, shipping company, or other logistics site, system, or partner) can operate as a trusted system where the user information code is used to access and apply the personal information (e.g., the address).

In one implementation where the implementing computer system includes or is a digital online e-commerce store, then the first party may be the buyer of an item and the second party would be the recipient of the purchased item. In some variations, the third-party may be the operator of the implementing computer system. For example, an e-commerce site may implement the system and method. In other variations, the third-party may be authorized to interface with the implementing computer system, which may be operated by another distinct entity (i.e., the operating party). In some cases, the collected user information or part of the user information may be expired or otherwise deleted automatically upon satisfying some condition (e.g., confirmed use/access and/or a time window).

As an example of use, the system and method may be used within an e-commerce platform used for making business purchases for business partners, clients, customers, colleagues, and the like. In a business setting, one will often not have knowledge of someone's home address and requesting such information directly may, for some, seem intrusive. Using the system and method, one party could order an item for one or more people where user information codes are used as a proxy for a shared delivery address. As discussed herein, this may be achieved through various models. In one variation, this may be achieved by using the user information codes directly in place of an address. In another variation, this may be achieved by the one party providing a communication address of the recipient which is used by the system and method in collecting user information code and delivery address information. This can similarly be used for large number of orders, which may be organized as a campaign.

As discussed, the system and method may additionally or alternatively be applicable in use cases other than parcel delivery. The user information codes may be used as proof of some information without directly providing that information. In one example, a building guest-list application could be configured to request ID confirmation to confirm the identity of an individual. In this example, a user may pre-generate a user information code that is associated with a verified photo ID (e.g., a validated government issue ID). When a user checks-in at the building, they can enter their name, share their user information code, and then the name can be confirmed to match the user information associated with the user information code using the method. A similar process could be used to verify insurance cards or other forms of information. Other suitable use cases may also be adapted to the system and method.

The system and method may provide a number of potential benefits. The system and method are not limited to always providing such benefits and are presented only as exemplary representations for how the system and method may be put to use. The list of benefits is not intended to be exhaustive and other benefits may additionally or alternatively exist.

As a first potential benefit, the system and method can offer enhanced personal privacy protection for recipients. The system and method can enable a user to be a recipient of a delivery without having to also trust the sender with address information.

As a related potential benefit, the system and method can enable managed control over user information. The system and method may provide unique levels of control to a recipient by enabling address information to be limited for use with a specific sender, campaign, delivery, time period, or other scope of limitations. Similarly, the use of the information can be changeable and revokable even during the order/delivery processing. Furthermore, these different rules or policies could be customized for different participants.

As another potential benefit, the system and method may additionally provide mechanisms whereby collected user information can be automatically deleted, expired, or otherwise removed from storage. In some cases, this may be conditional on completing “use” of a user information code, a time condition, and/or other suitable conditions. For example, a fulfiller or ecommerce site may be able to access address information associated with a user information code long enough to get the address and print a label but then the system and method could automatically sanitize the records to delete any personal, private, and/or sensitive stored information.

As another potential benefit, use of the user information code can make sharing of information more resilient and flexible. As an example of resiliency, by sharing a user information code for a delivery address, the user can easily update all mailing by updating their delivery address for a user information code. For example, a student at college that changes their address every year, could have mail and shipments seamlessly update to sending to the student's new address without needing to individually update each entity using their old address. As an example of flexibility, a user could generate multiple user information codes and control those independently. They could generate one that they share with close friends and family, and then they could make one for a single use.

As another potential benefit, the system and method can improve engagement between companies and users. The security of the personal information may enable companies and users to engage more comfortably, without concerns around sharing personal information. The system and method are particularly well suited for adapting to the emerging trends in remote work.

As another potential benefit, the system and method can provide more accurate addressing information since it can be confirmed directly with the recipient. Additionally, the system and method can enable an ability to update an address without having to notify senders.

As another potential benefit, the system and method may enable a user to create a user profile. The user profile may be used to supply user information such as address information, contact information, phone number, item size options, color options, food preference, allergies, and/or other user information or preferences. This information may, in some variations, be added as user information independent of creating or using a user profile. This type of user information may be automatically applied in processing or generating orders for the user. In one variation, clothing sizing options may be automatically applied to select correct clothing sizes when ordering an article of clothing for the user. In another variation, food preference or restrictions may be automatically applied to select between different product options or to prevent ordering of a particular item. For example, a user may update their profile with information regarding a nut allergy. This allergy information can be used to allow companies to avoid sending a gift item to which that user is allergic. This may lead to better customization of orders for a user, and/or to avoiding waste by ordering items undesired by the user.

As another potential benefit, the system and method may provide a more efficient and automated solution for sending parcels. This may particularly apply in the business setting. The system and method can help sales teams securely get personal mailing addresses for gifts, events, and the like. The system and method may additionally remove the time-consuming hassle of manually collecting home addresses, thereby alleviating the burden on administrative assistants.

As yet another potential benefit, the system and method may enable more advanced shipment logistics. The user information code enabled addressing mechanisms can enable dynamically controlled addressing in shipment logistics. This can be used to adapt addresses in real-time during the shipping process. For example, if an individual were to use the system and method for subscribing to an item (e.g., a magazine, good subscription, etc.), then that user can dynamically update the delivery of this item up until the moment it gets prepped to ship. For each new delivery of the subscribed good would have the address newly updated. This may be used for dynamic setting or changing of addresses during order processing. For example, in some versions, a user information code may be used for multi-stage delivery such that an item may be processed and delivered while the address is kept dynamic up until the last leg of delivery. This may be used so that an item could be first sent to the city/region where a recipient lives and then depending on detected location of the user, the address updated again at a logistics/shipping center to deliver to the current location of the user (e.g., at work or at home).

As another potential benefit, the systems and methods may also enable businesses and companies to avoid storing PII data in their systems. This can reduce risk of liability, especially around regulations like GDPR and CCPA. For example, a CRM system could make use of user information codes of the systems and methods in place of mailing addresses or other user information.

As another potential benefit, employers could offer use of the systems and/or methods to its Employees to protect their privacy when it comes to sharing their PII data with colleagues or business partners. This can ensure the safety and privacy of their employees' data, especially in the new remote work environment. HR Systems could keep user information codes for each employee and Employee user information codes could be shared via a corporate directory (which would be at the discretion of the employee).

### 2. System

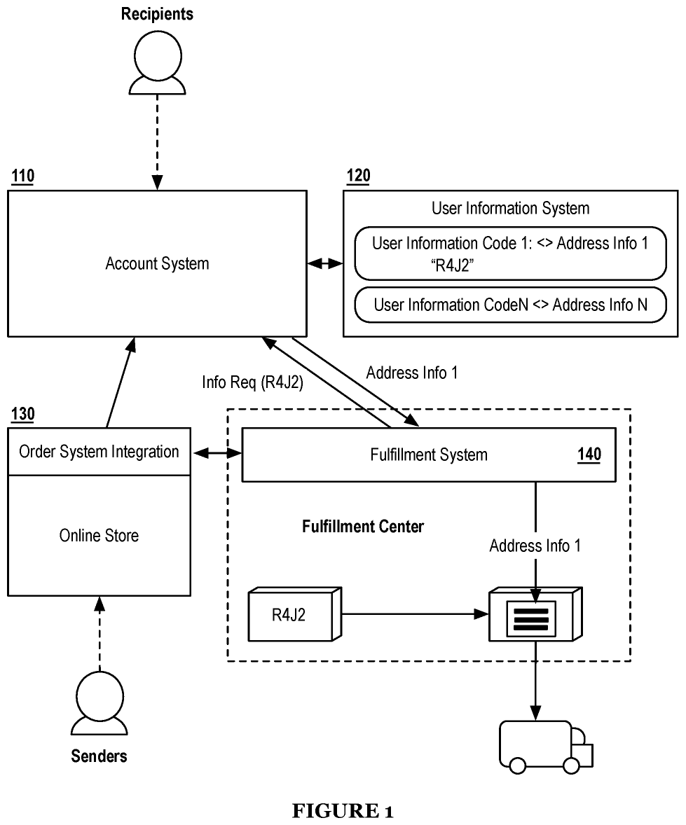

As shown in FIG. 1, a system for privatized parcel delivery can include an account system 110 integrated with a user information system 120 and at least one order system integration 130. The system may additionally include a fulfillment system 140. The system functions to enable management and application of a user information code. In particular, the system can be used in managing the logistics of shipping parcels to a recipient while preserving privacy of the recipient address. The system may be used so that senders could send parcels to a recipient without ever having access to the address information of the recipient.

The system is preferably configured to implement the method and/or method variations described herein, though the system may be adapted to other suitable variations. Accordingly, the system may be a non-transitory computer-readable medium storing instructions that, when executed by one or more computer processors of a computing platform, cause the computing platform to perform the operations: generating a user information code and updating a user information system recording an association between the user information code and user information, establishing an association of a user information code with a delivery order, and servicing information requests that include the user information code. Stated alternatively, the system may include one or more computer-readable mediums (e.g., non-transitory computer-readable mediums) storing instructions that, when executed by the one or more computer processors, cause a computing platform to perform operations comprising: generating a user information code and updating a user information system recording an association between the user information code and user information, establishing an association of a user information code with a delivery order, and servicing information requests that include the user information code.

The account system 110 functions to manage the account data of the users. The account system 110 can enable users to create an account within the implementing computing system. In some implementations/instances, the account may be user-managed such that a user may later access account related data and, in some variations, perform various actions. In other implementations/instances, the account system no may create an anonymous account, which a user may not have access to, unless they later link the anonymous account to a user-managed account.

The account system 110 can support user accounts that have data managed at least in part by a user information system 120. The user information system 120 is preferably used in storing and managing user information codes and information stored in association with the user information codes. In some exemplary applications of the system, recipients of a delivery order would have user accounts with user information code. A sender could use the user information code of the recipient to send an order to the recipient.

The account system 110 can include a user interface through which a user can access and interact with the account system no. In the user interface, a user can supply user information, likely in association with a user account profile, and a user information code can be output. In some cases, the user information code is randomly generated. In some instances, or variations, the user information code can be selected or specified. Some validation of a user supplied code may be performed to make sure there are no conflicts with using the supplied code. Additionally, the account system no can include a separate interface or include as part of the general account system user interface a management interface. The management interface may be used to see all user information codes and the associated user information, edit user information, change policy for one or more user information codes, and make other suitable changes.

In some variations, the account system 110 may additionally provide a search interface through which other users may search and find user information codes of different users. In some cases, the permissions and/or settings for a user information code may limit if and when a given user information code is returned during a query. For example, a user may set their account so that only users with certain company affiliations (e.g., an email account from one of a set of companies) may see their user information code.

The account system 110 or the system more generally may include a communication module for messaging or communicating with a user. This may be used for emailing, calling, messaging, or otherwise communicating with the user. For example, in some situations, a user may be messaged if a new company is requesting access to a user information code. Similarly, a user may change their address, update their password, manage their user information code(s), and/or make other changes through the account system 110.

The user information system 120 functions to maintain data modeling of user information codes, associations with user information (e.g., recipient addresses or other PII data), permissions, and/or other related data/information. In a preferred implementation, the user information system 120 is used to securely store associations of user information codes and delivery addresses for various recipients of parcel deliveries.

A user information code can be an alphanumeric code or any suitable type of code. In some variations, the alphanumeric code may be a randomly assigned code. In some variations, the alphanumeric code may follow a particular protocol or format. In some variations, the user information code may encode information. The user information code may be created so that it is easily transcribed by a user. These variations may be used when user information codes are shared publicly. The user information code may alternatively be a longer code, however. In some cases, the user information code may be generated or formatted as a graphical user information code or another format of machine-readable codes. For example, a barcode or QR code may be used as the user information code. In some variations, the user information code, may not be intended for distribution external to a computing system and as such may natively be primarily formatted for machine usage. In some variations, the user may supply their own user information code to be used. This user information code may be verified to be unique and/or to match certain rules.

The user information system 120 may, in some variations, facilitate data management. In one variation, the user information system 120 may manage expiring user information. In one example, user information for a user information code may be deleted or otherwise removed after some access condition. An access condition could be based on a count of types of data access such as when user address information is provided for adding to a packing label. An access condition may also be based on time of holding the data. For example, data may expire after a week of time. The account system 110 may additionally manage accounts of other participating entities. In some variations, a user account may additionally or alternatively be used by the senders. A sender account (or an account with sender account data), stored within the account system no, can manage accounts used to request access to user information codes.

In some implementations, a sender user account may use the account system 110 to manage transmitting requests to a recipient user account so that collected user information codes may be used for sending parcels.

In one variation, a user account, when acting as a sender, can create a campaign, and within the context of that campaign can collect multiple user information codes. The user information codes may be unique to the campaign. In some variations, a campaign may be integrated with a CRM system of the holder of the sender user account. In some variations, the CRM system may have a field for a user information code.

In some variations, the account system may additionally manage associations with a client device. This may be used in variations where location information of a client device is used for augmenting the selection and determination of a delivery address. A client device association may be established by a client device with an account system application installed. The application can be granted location permissions so that location information can be automatically reported or periodically reported. The application may also be the source of a user interface for an account to manage user information codes and user information. In some cases, the application may be used to present an audit trail of user information code(s) and/or their use. This may be used to show usage and status of a user information code. In some cases, it may also show how private information is deleted or removed from the system automatically.

The order system integration 130 functions to incorporate an item ordering system with the account system 110. The ordering system can establish a data association between an order (an item delivery task) with the user information code. In particular, an order may have the user information code used in place of or within the recipient address information for the order.

The order system integration 130 may be an integration into an online website or service that is used in selecting items for delivery. Such online websites or services can include e-commerce stores, document/mail order sites (e.g., for sending holiday/thank you cards, food/gift-box delivery, taxi/car-ride services), and the like.

In one variation, the order system integration 130 may be implemented as an e-commerce store with integration with the account system 110. This could be a plugin that enables an ordering system of an e-commerce store to automatically integrate with the account system 110 for enabling use of user information codes in place of delivery addresses. Alternatively, the account system no may be integrated directly within a computing system of an e-commerce store.

In connection with an order system integration 130, the system may include a user information communication module that facilitates communication with and collection of user information. As one example, when placing an order on an e-commerce store, a sender may enter one or more recipient email addresses (in place of recipient address information). The email addresses (or other digital communication addresses) can be used for communication of a message with a link to a web-accessible resource through which the user may supply destination address information. By submitting address information, a user information code may be generated or made usable for the sender.

The order system integration 130 may, in some variations, be optional and not included in the system. For example, in some instances or variations, a user may create a user information code, and then use that user information code outside the system. A cooperating fulfillment system 140 may then be used to detect presence of a user information code when processing parcels and request transformation of the user information code into usable user information (e.g., into a delivery address).

The fulfillment system 140 functions as a system or integration through which a user information code can be translated into the desired user information. The fulfillment system 140 may, in some variations, be implemented at a parcel processing site where it can more specifically function as an intermediary system for exchanging a user information code (e.g., delivery code) for a delivery address.

The fulfillment system 140 in one variation may be part of or operated in coordination with the order system integration 130. The fulfillment system 140 can be configured to automate the retrieval of user information when an order is being processed for delivery. The user information may then, in the case of sending a parcel, be used as the destination address of the parcel. For example, the warehouse of an e-commerce site may have the fulfillment system 140 detect if and when a user information code is present in the data records of an online purchase order. Then prior to printing the shipping label, the fulfillment system 140 can perform operations for retrieving the corresponding delivery address information.

The fulfillment system 140 in another variation may be part of the processing of received packages. In this variation, a parcel may be prepared and/or initially sent with a user information code. The fulfillment system 140 can detect such a parcel and appropriately process the parcel such that it can continue to a final destination.

In one variation, a delivery service may include integration with the system such that a user information code may be recognized and used to query corresponding user address information. For example, mail processing equipment of a mail processing site (e.g., the USPS) may detect a user information code and look up a corresponding mailing address for the given code. In such a variation, the system may be integrated into a database system of the postal service and/or another suitable parcel processing system of the postal service so that user information codes may be automatically detected and processed according to their corresponding address information. This may be used such that user information codes can be used for peer-to-peer addressing.

In some variations, the fulfillment system 140 may include or incorporate mail processing devices such as an imaging system. The imaging system may be configured to collect image data. The image data can be processed to detect and extract user information codes. The mail processing device can be configured to specially handle a parcel detected with a user information code by translating the user information code and updating the delivery address.

In some variations, the system may include an application programming interface (API) through which requests for user information can be submitted. The fulfillment system 140 may make use of the API to access user information. The API may enable external systems to submit data requests along with a user information code. In response, the data request can be processed and, if successful, user information can be communicated in response. The API may be used within a variety of implementations.

### 3. Method

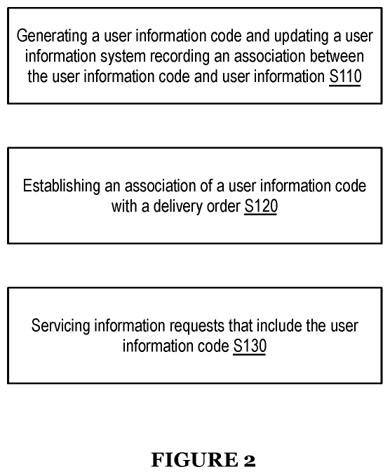

As shown in FIG. 2, a method for privatized use of user information can include generating a user information code and updating a user information system recording an association between the user information code and user information S110, establishing an association of a user information code with a delivery order S120, and servicing information requests that include the user information code S130. Such a method functions to enable the generation and use of a code in place of private information, while automating limited permitted use of the private information when required. The method provides a system and process by which access, and use of the code can be performed to complete various tasks that depend on the private information.

The method may be implemented by a specially configured computer system such as the one described above, but alternatively other systems or variations of the system may alternatively be used.

The method may additionally be implemented in a variety of formats depending on the configuration of different system integration and the form of involvement of the various parties.

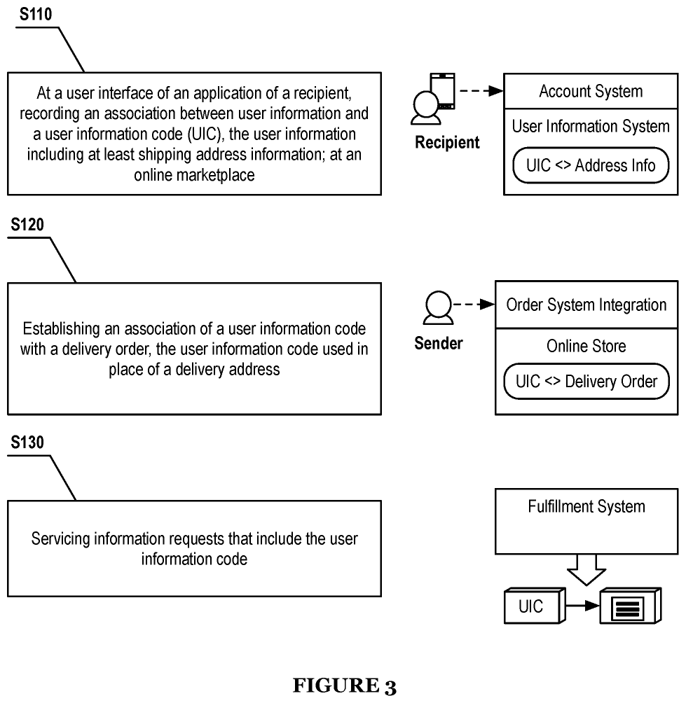

In one variation, the method is used for privatized parcel delivery enabling protecting of address information of a parcel recipient, wherein the method, as shown in FIG. 3, may include: at a user interface of an application of a recipient, recording an association between user information and a user information code, the user information including at least shipping address information; at an online marketplace (S110); establishing an association of a user information code with a delivery order, the user information code used in place of a delivery address (S110); and servicing an information request that includes the user information code, the servicing the information request comprising generating a packing label of a product using the shipping address information accessed with the user information code (S130).

In such a variation, the user information code may be received or used in place of a delivery address. For example, a recipient could provide the user information code in place of sharing private information like their home address. In another example, someone generating orders for a large number of individuals could use current communication address to automate and securely collect and use user information like address information. In another example, the user information code could be used as a mechanism whereby indication of the desired information could be deferred until some later time or condition when customized information can be dynamically provided at that time. As a more specific example, customized shipping address information can be provided as part of a last-mile package processing process.

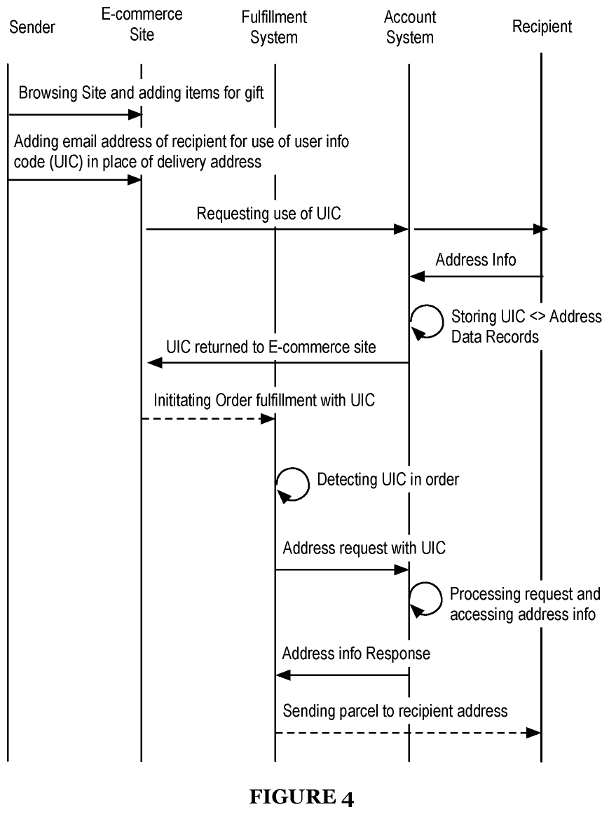

In a first exemplary variation using address information, the system may be used in connection with an online store. In such a variation, as shown in FIG. 4, a sender may select one or more products to purchase and then, during checkout processing, facilitate associating a user information code with the purchase. In general, this may include adding the user information code to the shipping address information or alternatively using the user information code in place of the shipping address. In such a variation, a recipient can have their address information kept private from someone sending them materials while still being able to receive packages or parcels from a sender.

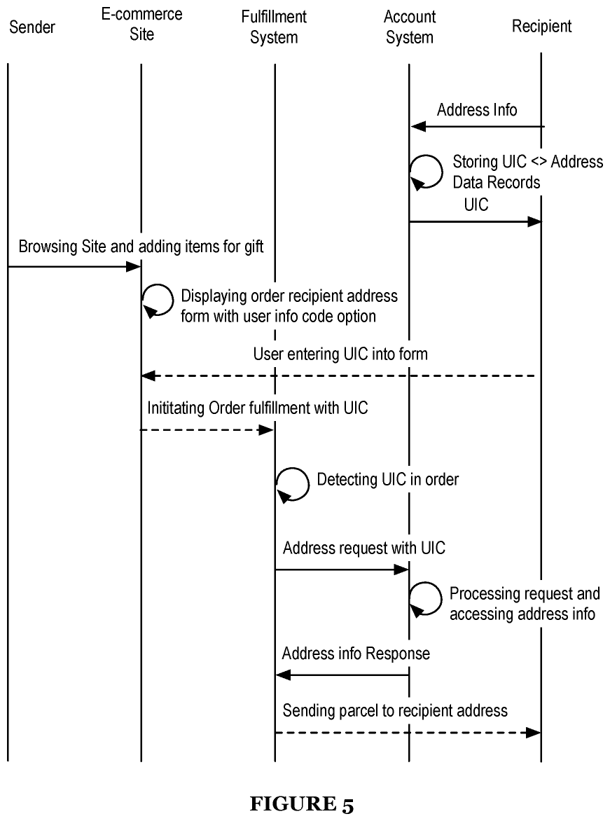

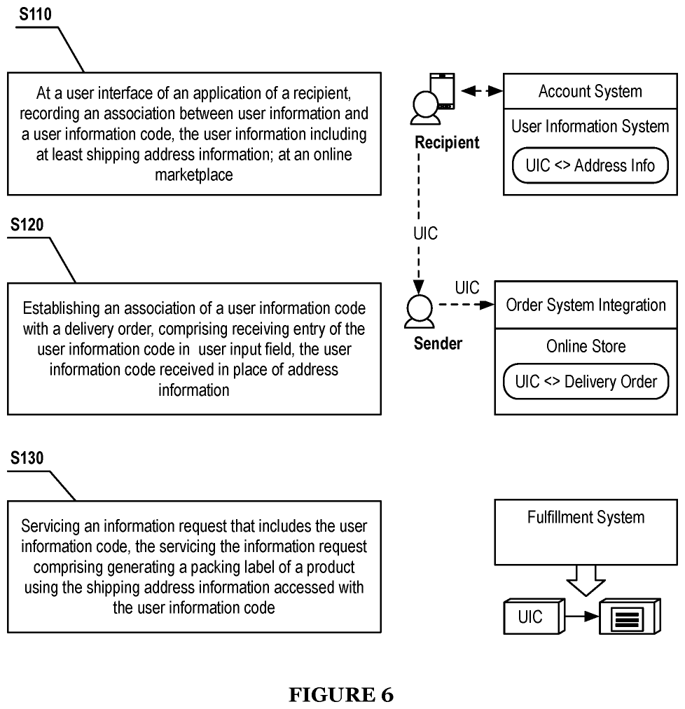

In one variation, such as shown in FIG. 5, the sender may enter a user information code if, for example, they were provided the user information code through another outside channel. In one exemplary instance, a recipient may have an existing user information code. In another exemplary instance, a recipient may generate a user information code and share that user information code with a sender after the sender requests their address (e.g., FIG. 6).

As shown in FIG. 6, a method for privatized parcel delivery may include: at a user interface of an application of a recipient, recording an association between user information and a user information code, the user information including at least shipping address information; at an online marketplace (S110); establishing an association of a user information code with a delivery order, comprising receiving entry of the user information code in user input field, the user information code received in place of address information (S110); and servicing an information request that includes the user information code, the servicing of the information request comprising generating a packing label of a product using the shipping address information accessed with the user information code (S130). Recording the association between user information and the user information code may be part of creating a user account for a recipient, wherein a user information code is outputted by the user interface upon recording the association. This outputted user information code could be an alphanumeric text code, a graphical, machine-readable code, or any suitable sharable mechanism that can be used as a searchable index to later identify associated user information such as a shipping address of the recipient. Use of the user interface by the recipient can be part of pre-registering an account so that user information codes can be used for later requests for private user information like their address.

In another variation, such as shown in FIG. 4, the sender may initiate a request that is digitally communicated to the recipient for setting of the user information code.

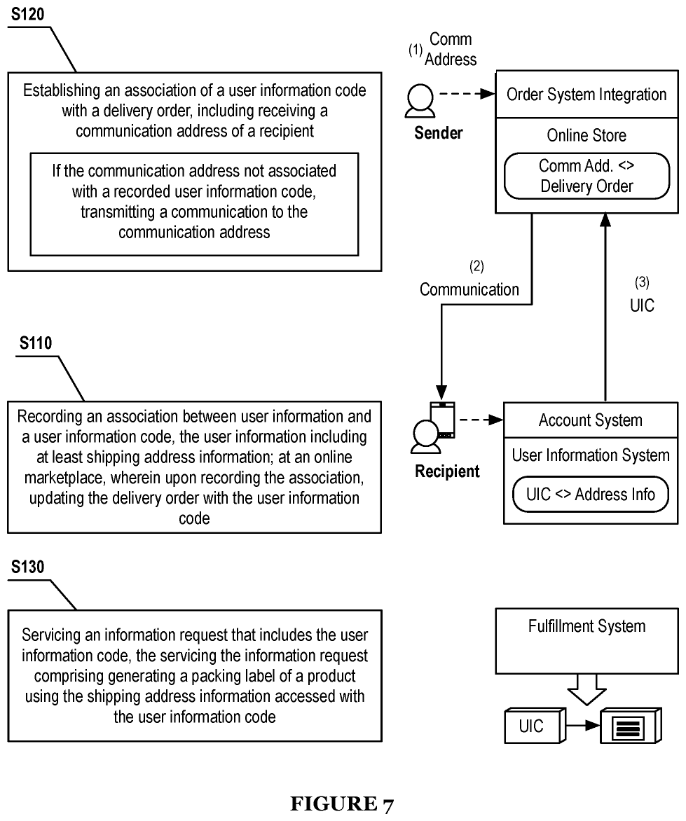

As shown in FIG. 7, a method variation for privatized parcel delivery may include: establishing an association of a user information code with a delivery order, comprising receiving a communication address of a recipient, if the communication address is not associated with a recorded user information code that includes desired user information, transmitting a communication to the communication address with a link to a user interface for creating user information code record with the desired user information (S120); at the user interface of an application of a recipient, recording an association between user information and a user information code, the user information including at least shipping address information; at an online marketplace (S110), wherein upon recording the association, updating the delivery order with the user information code; and servicing an information request that includes the user information code, the servicing of the information request comprising generating a packing label of a product using the shipping address information accessed with the user information code (S130).

In this variation, a sender may not have a user information code for one or more recipients and can instead use a communication address such as an email address, a telephone number, a user account name (e.g., for a messaging application or platform), and/or any suitable endpoint used for digital or electronic communication. The recipient could receive a communication (e.g., an email, a text message, etc.) with a link or other type of access to a user interface, through which a user may create an account or otherwise establish a user information code that can be used with the delivery order.

In some variation instances, a record for a user information code may be stored in association with the communication address. In this case, the user information code may be automatically used in place of communicating with the communication address. For example, if a sender enters an email address of a recipient that has already created an account that is associated with that email address and also has a public user information code, then that user information code may be retrieved and used in establishing an association between the user information code and the delivery order.

In some variations, access may depend on the permissions set for the user information code. In such variations, automated access to a user information code and/or elements of user information may depend on the permission configuration for the account and/or user information code. In this way, if a restriction prevents access, communication may be triggered to request input by a recipient account to resolve the issue (e.g., request an accounts permission to share the user information code and address information to the requester).

Use of a communication address may additionally be accompanied by automated follow-up. For example, reminders could be sent if the recipient does not respond. In another example, the sender (e.g., the party initiating the order request), may receive updates on the status of the order.

With the method's potential benefits in a business setting, the method may have particular use in situations where bulk orders are being made for a large number of recipients. The method can similarly be adapted so that bulk ordering can be automated while privatizing the parcel delivery information. Accordingly, in some variations, the sender may initiate an order of a product for a set of different, independent recipients. For example, a company may wish to send a gift to all their clients—the method can provide a computer-implemented process by which this can be facilitated.

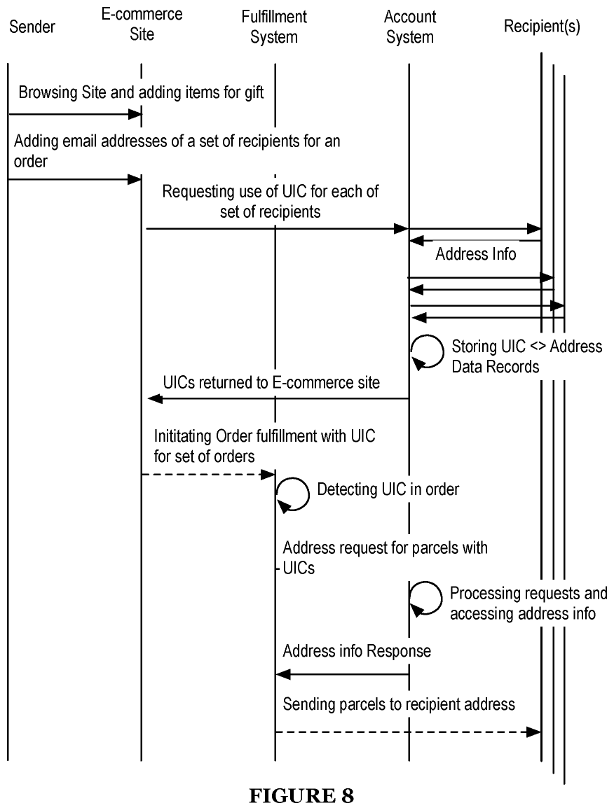

As shown in FIG. 8, such a method variation may include: establishing an association of a user information code with a delivery order (S120), comprising: receiving a set of communication addresses for a set of recipients; for each of the set of communication address: if a given communication address is associated with a corresponding recorded user information code with shipping address information, processing an order instance using the corresponding recorded user information code; if the given communication address is not associated with a corresponding recorded user information code with shipping address information, transmitting a communication to the communication address with a link to a user interface for creating user information code record with the desired user information; for each of at least a subset of the set of recipients, recording associations between user information and user information codes, the user information including at least shipping address information; at an online marketplace (S110); and servicing an information request that includes the user information code, then servicing the information request comprising generating a packing label of a product using the shipping address information accessed with the user information code (S130). In some variations, after servicing an information request (and/or any suitable alternative condition), the user information and/or the user information code may be deleted or otherwise sanitized.

Similar to above, delivery order instances can be updated for a recipient, upon recording an association for that recipient. The delivery orders can be processed and updated independent of other delivery orders. For example, delivery orders can be finalized or triggered as delivery address information and/or user information codes become available.

In alternative variations, the shipping address information described above may additionally or alternatively be any suitable desired user information associated with the user information code.

In such exemplary variations, the user information code can be associated with address information of the recipient. During fulfillment of the order, the user information code that is stored in association with the purchase order may be used at the fulfillment center or by a shipment logistics system for retrieving the address information of the recipient and using that in shipping the order. In some variations, the method may address authentication and automated information policy enforcement. The method may additionally or alternatively enable unique forms of logistical processes within automated parcel processing systems.

In one variation, the method may include a variation wherein the information request comprises account credentials of a requesting account, and wherein the servicing the information request further comprises authenticating the request based on access permissions of the account credentials and the user information code. For example, a fulfillment center may be allocated an account with account credentials. Automated systems of the fulfillment center can be configured with the account credentials such that those systems can automatically make requests as that account. A management system can authenticate requests and appropriately provide access to user information codes and/or related information.

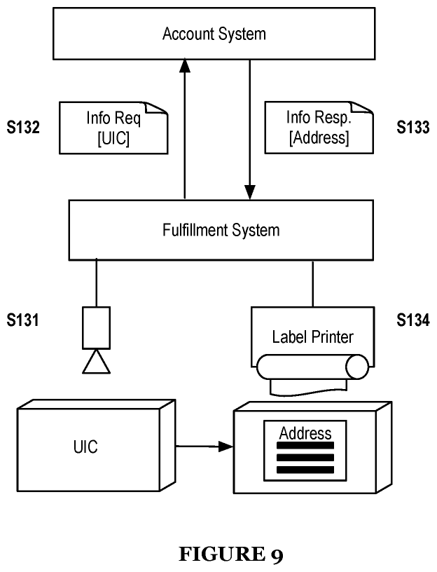

In some variations, the method can enable dynamically modifying parcels so that information codes can be detected and updated to include appropriate shipping address information. In such variations, such as shown in FIG. 9, servicing an information request (S130) may include: at a shipment processing system, automatically detecting a user information code on a package and initiating the information request S131; at a database system, retrieving shipping address information associated with the user information code S132, and sending a response to the information request including the shipping address information S133; generating a packing label of a product using the shipping address information, which comprises printing and applying the shipping address information to the package S134.

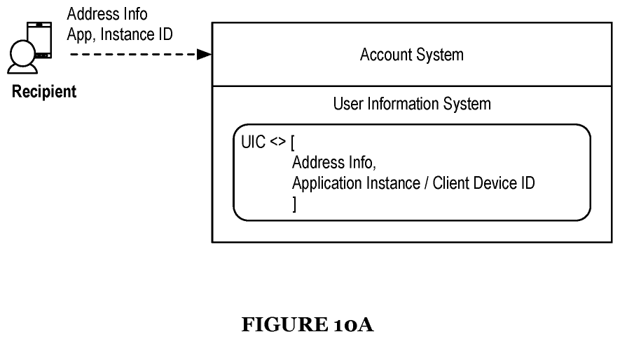

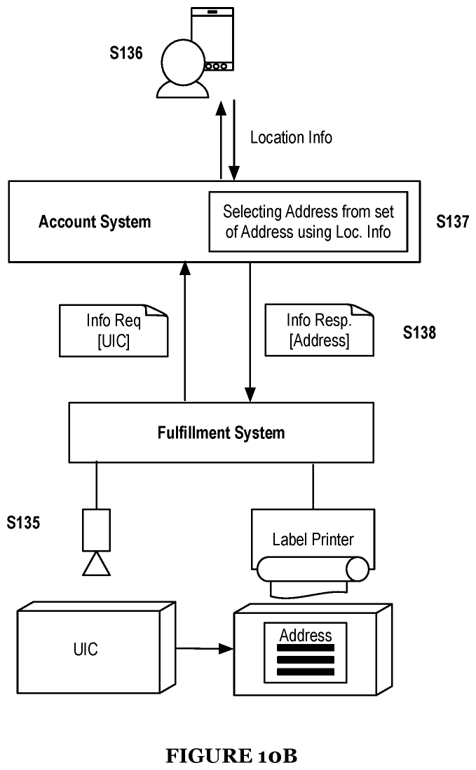

In some variations, the method may be used to enable dynamic delivery of an order. In one example, this may be used so that orders can be dynamically routed based on a detected location of a recipient. Such a method variation may include: at a user interface of an application of a recipient, recording an association between user information and a user information code, the user information including at least a set of delivery address options; at an online marketplace, and when recording the association between the user information and the user information code, registering a client computing device configured with a location service (S110) as shown in FIG. 10A; establishing an association of a user information code with a delivery order, the user information code used in place of a delivery address (S120); and, as shown in FIG. 10B, servicing an information request that includes the user information code, (S130) comprising during automated package processing of a delivery stage, detecting the user information code and requesting address information in the information request S135; at the client computing device, detecting location relative to the time of the information request S136; selecting a shipping address information from a set of delivery address options based on the location S137; and transmitting the shipping address information in response to the information request S138.

This may be used as a final leg routing process. For example, right before a delivery truck route is assigned for the final leg of a delivery request, the method can enable the package to be routed to one of a set of addresses that is more contextually appropriate at that time. This may also be used in intermediary shipping stages to regionally route a package based on location. As a related example, the user may not have any stored delivery address information, and instead a delivery address may be automatically determined by the location information of the client computing device.

In one exemplary implementation, the method may enable senders to manage the use of user information codes. In one example, Company A may want to send Company-themed shirts to individuals. Shop X creates Company A shirts and ships them to whoever Company A wishes. Shop X may be a trusted fulfiller and authorized to access information of the user. Company A may have a corporate account with the account system 110 of the implementing system. Company A could set up a campaign that would count towards their account/subscription. Company A would send Shop X their campaign ID and would send invite emails to each of the individuals they wish to send a shirt. When users clicked the invite email, they would be invited to log in or sign up, after which they would be added to the campaign. Then, Shop X could be emailed a list of user information codes. Shop X can use their authentication token to send a GET request (or other suitable type of HTTP request) with Company A's corporate account ID and the user information codes in the payload. The implementing computing system will return the addresses and names corresponding to those IDs, and Shop X will use that information to complete the order. In some variations, Shop X could see a list of the user information codes for a campaign from their dashboard in future instances and there could be a conversion of user information codes to addresses directly from the shop site. In some variations, the user information may include other user-related information such as item size options, color options, food preference, allergies, and/or other user information, which may be used in customizing product selection. When sending gifts this user information or analysis of user information may be used to automatically adjust gift selection and/or customization for each recipient. In this example, the recipient may enter t-shirt size preferences of medium, and this information may be used in selecting the medium size option for a t-shirt gift.

In a second exemplary implementation, a sender may receive or access a user information code, which may occur through a variety of channels. In one case, a user may directly give the sender the user information code or publish their user information code (e.g., including it as part of their contact information). In some implementations, the user information code in combination with an address to a participating fulfillment center may be used for posting a parcel. The parcel, while at the participating fulfillment center, can have the user information code recognized, and, in response, the user information code is used in retrieving address information. The retrieved address information is then used in updating the shipping address of the parcel delivery.

Block S110, which includes generating a user information code and updating a user information system recording an association between the user information code and user information, functions to establish an association between a user information code and at least one piece of user information. As mentioned, a piece of user information, for which the user information code may be used, could be or include address information. More specifically, the address information may be shipping address information, which could be used as a destination address for a parcel.

Additionally or alternatively, the user information code may be associated with a variety of different types of sensitive or private information. In one variation, the user information associated with the user information code include various user information that can be used in determining parameters or options for a shipment order. For example, the user information may include user sizing information (e.g., clothing size), color preferences, and/or other information. This could be used, for example, so a company could send a recipient a t-shirt without requesting shirt size or address information.

In another variation, the user information associated with the user information code could include verifiable or certified information such as a copy of or a certification of a government issued ID (e.g., driver's license or passport), insurance card info or status, and/or other types of information.

Generating a user information code will generally include receiving from a user the user information. This will generally be collected through a form submitted through a user interface of a web application or a native application. This user interface can be one shared with or otherwise offered to a recipient.

The user information code can be any suitable type of mechanism that can be communicated. In general, the user information code will include a text-based format (e.g., be an alphanumeric code). The user information code may additionally or alternatively be or include a visual code or another form of machine-readable code.

Recording the association between the user information code can include storing in a database system one or more data records that establish an association of the user information code and user information. In one example, a database record may store the user information code with a reference to a user profile containing user information. In another example, the database record may store a database record that includes both a user information code attribute and a user information attribute(s). Any suitable data model may alternatively be used in recording the association. Such a data record may, in some variations, additionally include communication address information such as email, phone number and/or another type of addressable endpoint. This may enable information codes and/or address information to be used as a mechanism for requesting such information or accessing such information.

In some variations, user information codes may be restricted in their usage. Accordingly, a user information code may additionally be recorded with an association to data that impacts the policy of how the user information code may be used. For example, a user information code may additionally be recorded in association with usage related information relating the user information code to the entity or context of how a user information code may be used such as an account ID for the company, a campaign ID, an order number, user information (like a name) and/or other information.

In one variation, an account within a managing system can enable multiple user information codes to be generated for the same or shared user information. Different user information codes may have different permissions or usage limitations. For example, an information code may be restricted for use in association with one company.

User information codes may also have usage limitation rules. For example, a user information code may have a usage expiration window (before or after which the user information code may not be used). In another example, the user information code may have a usage limit count or usage frequency limit, and/or any suitable usage-metric related limit.

Such limitations, rules, and/or other policies related to a user information code can be configured through a user interface. Alternatively, certain policies may be automatically applied.

Block S110, may be performed at a variety of times and in a variety of ways.

In one variation, block S110 may be performed prior to activity relating to the use of the user information code. For example, a user may create an account with an implementing computer system and initiate the generation of the user information code in anticipation of using the user information code. In some cases, this may be done such that a user can directly provide a user information code when they want to use it. For example, a user may generate a user information code and then provide the user information code to others directly. The receivers of the user information code can use this information in place of or as an alternative to a digital input field like an address field.

Generating the user information code may also be integrated into other digital systems. In some variations, a user information code could be generated as part of a user on-boarding system. In this way a user information code can be created and used internally for employees, clients, attendees to an event, or other groups of users. In one example, a user information code could be automatically generated (or optionally generated based on user selected options) for attendees to a tradeshow event as part of the digital registration process. In another example, a business may offer employees the option to sign up for a user information code which could be used internally within an employee/HR management system.

In another variation, an event may be triggered that initiates digitally requesting the user information code. For example, while purchasing a gift, a sender may be prompted to enter an email address of a recipient, which then in turns initiates communication to the recipient where they may select a preexisting user information code. Alternatively, the recipient may create a user information code.

In another variation, block S110, may be performed in response to a digital event that triggers the generation of the user information code. When used within e-commerce, the event may be when a sender is adding address information to a purchase order. As a variation of the example above, while purchasing a gift, a sender may be prompted to enter an email address of a recipient, which then in turns initiates communication to the recipient where they provide their address information thereby initiating the generation of a user information code and communication of the user information code for use with an order.

Block S120, which includes establishing an association of a user information code with a delivery order, functions to use a user information code in connection with a parcel shipment.

In alternative applications of the method, S120 may be performed such that a user information code can be used in combination with any digital transaction. In the example recited above, building records may record a user information code in their guest records, where the user information code can be used to confirm or verify identity.

The association of the user information code and the delivery order may be maintained digitally within a data system that is used in the processing of the delivery order. In one such variation, establishing the association of the user information code with a delivery order can include storing the user information code as a data attribute of a delivery order.

In variations, where a user information code is supplied as part of the delivery order, the method may include receiving a user information code through user input of a user interface. For example, an input option can be presented whereby a sender could enter a user information code. This could be an explicit input field for user information codes. This may alternatively be an existing/alternative input field through which a user information code can be entered and later detected.

In one variation of an e-commerce purchase order, the user information code may be included in the shipment address attribute. In one such example, the user information code may be accepted and entered into a street address field, while other address information may be completed in an appropriate manner (e.g., with the city, state, and zip code information of the recipient) or arbitrary manner (e.g., with any city, state, and zip code to result in a validated address form). Alternatively, the user information code may be stored as an alternative to or in addition to a shipment address.

In some variations, receipt of the user information code is processed by directly storing the user information code by an online marketplace. As a result, shipment labels may be initially generated using the user information code instead of a label with the delivery address. This variation may, for example, enable marketplaces to place orders without having information of the final delivery address. This variation may involve generating shipment labels that incorporate the user information code so that a subsequent parcel processing system can manage interpretation and transformation of the user information code.

Alternatively, after entry of the user information code, a managing system (e.g., the online marketplace) may facilitate detecting presence of the user information code for a delivery order and initiate an information request through block S130 so that delivery address information can be internally stored and used in processing the delivery order. This variation can still preserve the privacy of the recipient since the delivery address information can be hidden from the user making the order. Furthermore, in some variations, the user information associated with a user information code may be automatically deleted or removed from the system after completion, use, a certain amount of time, and/or other suitable conditions.

When a user information code is used in a digital delivery order, processing of the delivery order may partially use the user information code to finalize the order.

As one optional process, the method can include verifying access to user information for a provided user information code. This functions to validate that a user information code provided by a sender can be used to supply the desired information. For example, after detecting use of a user information code for a delivery order, the managing system can verify that the user information code is valid and can be used in association with the delivery order. As discussed above, some user information codes may be limited to different accounts (e.g., only subset of senders may be permitted to use a user information code). Validation can also confirm that the requested information (e.g., the delivery address), is still valid for a given user information code. In some cases, user information may expire after a certain amount of time or after lack of activity by the account.

In one variation this may include requesting shipment information using the user information code, which may be used so that shipping delivery estimates and/or costs/options can be provided when completing an order. In this variation, an online marketplace may collect a user information code, initiate an information request as part of S130, calculating shipping information for the delivery address associated with the user information code. The shipping information can include shipping options, shipping delivery estimates, shipping costs, and/or other information. In this way, a sending entity may order something for a recipient without their address but still afforded control over options like delivery date and cost.

In another variation, the method can include augmenting options of the delivery order based on retrieved user information. This may be used so that user information can be used in customizing products or contents of an order. For example, clothing size information stored as part of the user information may be used to order an appropriately sized t-shirt. In another example, name information stored as part of the user information may be used in producing a custom product (e.g., a coffee cup) using the name information.

In another variation, the method can include receiving a communication address in association with a delivery order, and then using the communication address to attempt establishing a user information code to be used with the delivery order. If the communication address is not associated with a recorded user information code that includes desired user information, transmitting a communication to the communication address with a link to a user interface for creating user information code record with the desired user information. If the communication address is associated with a user information code, then that user information code may be used with the delivery order. Use of the information code may depend on usage policy for the user information code. If policy determines the user information code cannot be used, then a communication to the communication address may be triggered. This could be used to request permission to share the information, to notify the user of attempted usage, or communicate any suitable type of action.

In another variation, block S120 can include receiving a plurality of user information codes and/or communication addresses. This may be used for bulk processing of orders. This may be used in situations, where identical or similar orders are being made for a large number of individuals. An implementation can support receiving a plurality of user information codes and then processing all of those to attempt establishing delivery orders.

In alternative variations of the method, a user information code may be used directly and established by incorporating the user information code into the physical addressing of a parcel. For example, a user may enter a user information code as the shipping address or as part of the shipping address. In another example, the user may print and/or apply a machine-readable version of the user information code (e.g., a barcode, a QR code, or other type of graphical code) on a parcel.

When user information code is used outside of the system, establishing the association of a user information code with a delivery order may include or otherwise be accompanied with detecting a user information code on a parcel. This may function to facilitate automated detection and translation of a user information code. When a user information code is used with a parcel, in one implementation there may be no visible delivery address information. This implementation may be used when user information codes are recognized by the receiving shipping institution. For example, a user can use just a user information code with a participating shipping entity that supports the user information code.

When the user information code is used with a parcel, in another implementation, there may be a proxy delivery address, which may be used to ensure the parcel is delivered to a participating site where the user information code can be properly translated. In one example, the user information code may be used as the recipient name in the address information, and the address can be a suitable delivery address to a participating parcel processing site.

In some implementations, detecting the user information code on a parcel can include detecting presence of a user information code in image data of parcels. This variation can include, at a parcel processing site, collecting image data of parcels, processing the image data (e.g., using optical character recognition, machine code detection and decoding), and detecting in the image data a parcel including a user information code. In other cases, a user information code could be detected through other machine-readable mechanisms such as RFID tags, barcodes, QR codes, and the like. When a user information code is detected, then a data system managing the parcel may be updated. More preferably, detection of the user information code by a system at a processing site will result in translation of the user information code into address information, and then optionally readdressing of the parcel. For example, a processing site may scan addresses of each package and/or letter, when a user information code is detected, this may trigger: retrieval of the associated address information, printing of a new label with the retrieved address information, and application of the label to the parcel.

Block S130, which includes servicing information requests that include the user information code, functions to respond to requests to appropriately deliver user information to facilitate translation of a user information code. Servicing information requests can include receiving a data request that includes the user information code, processing the data request, retrieving user information associated with the user information code, and transmitting a data response with the user information. In one implementation, this data communication exchange (e.g., receiving the data request and transmitting the data response) may be performed through an API. For example, a system at a shipment processing site may submit the data request using an API of the implementing computing system. In another implementation, the data communication exchange may occur internally within a computing system. For example, if a shipping organization provides the user information code service, then one computing service responsible for processing shipment orders may access a user information system used to store the association records for user information codes and user information. An API may be used to manage authentication, authorization, and data access. In particular, servicing an information request includes generating a packing label of a product using the shipping address information accessed with the user information code. In some variations, this may include a digital order system requesting delivery address information using the provided user information code, and then upon receiving the delivery address information updating the digital information for a packing label. Then a packing system can then access such a digital packing label and generate an appropriate label for a parcel.

In another variation, this can involve dynamically detecting presence of a user information code and appropriately updating a label of the parcel/package. This variation can include: at a shipment processing system, automatically detecting a user information code on a package and initiating the information request; at a database system, retrieving shipping address information associated with the user information code, and sending a response to the information request including the shipping address information; and then, when generating a packing label of a product using the shipping address information, printing and applying the shipping address information to the package. This can involve an automated system that includes a parcel scanning device (e.g., a camera, barcode reader, an RFID tag reader, etc.) and a parcel labeler (e.g., a printer).

In some variations, the data request may be translated without restrictions. In such variations, address information may be provided pending that the user information code is valid and that the address information exists. For example, upon receiving a request for address information, a provided user information code is used to query a database, and then any identified address information can be returned otherwise, a “no results” or error message can be sent in response.

Alternatively, in some variations, a user information code is translated in accordance with some policy that regulates access permissions. In such a variation, processing the data request may involve evaluating permitted access allowed for the data request.

Evaluating permitted access may include verifying account access permission. In this variation, the data request may include or be made in association with a requesting account, which may be identified by an account ID or other identifier. Additionally or alternatively, the data request may include or be made in association with a usage context such as an order number, a campaign identifier, or other usage related information. In some cases, a user information code may be limited to usage with only particular accounts and/or usage contexts. In some cases, the user information that is accessible for a given user information code may be determined, at least in part, by the requesting account and/or usage context. For example, a first shipping address may be associated with a user information code when the user information code is used by sender Company A, and a second shipping address may be associated with a user information code when the user information code is used by a sender Company B.

Evaluating permitted access may additionally or alternatively include verifying accompanied information of the user information code. In this variation, the data request may include verification information such as the recipient name, zip-code, or other information, the supplied verification information may be verified against information stored in association with the user information. If there is a match, then access may be permitted. If there is not a match, then the request may be denied, or some resolution process may be initiated.

Evaluating permitted access may additionally or alternatively include verifying usage limits of the user information code. In some instances, a user information code may be limited in how it may be used. Such usage may include permitted usage time windows (e.g., when the user information code expires), the number of usages (e.g., a user information code may be used a single time), frequency of usage, and/or other restrictions. The method, accordingly, can include tracking usage metrics for user information codes such that they can be evaluated. As one example, a campaign of a sender user account may have restrictions on the date (when the campaign is valid) and the number of user information codes that can be collected. Such restrictions may be enforced through API usage limits. In other cases, the limits may alter billing activity where different tiers of usage can be billed at different rates.

Similarly, in some cases, user management of their user information codes may impact the processing of the data request. For example, a user may update the information and/or status of a user information code through an online control interface. The user may disable a user information code, which could prevent subsequent use of the user information code.

As one particular variation, the method can support dynamic in-route updates to package processing. In particular, address information may be supplied dynamically based on external factors and applied to a package in route. In the method's support of in-flight control of shipment addressing, the method may enable a variety of computer-implemented variations that leverage the dynamic addressing nature introduced into the shipment logistics.

As one such example, the release of shipping address information may be staged such that a package is incrementally delivered to intermediary sites such that packages can dynamically be rerouted as it is moves between processing sites. For example, a package may be routed to a first large distribution center nearest an approximated address of a recipient; at the first distribution center, a new address may be used to a medium distribution center nearest to the city of the recipient; and then when at the local distribution center, a final address may be dynamically determined for last leg delivery.

In this way, packages may be delivered to the actual/predicted location of a user during the final/last leg of delivery. In some cases, as shown in FIG. 10A and FIG. 10B, this may include sensing and/or tracking location of a user. For example, a user may opt into providing location information to a mobile application via a client device associated with an account of a user information code. The location information may be used in predicting location of the user at different time windows, which may be then used to predict a final destination for delivery based on historical trends of the user's motions. In some cases, this may be used to select one address from a set of potential addresses (e.g., home address, work address, etc.). In this case, the method can include tracking location of a user and determining a set of candidate delivery addresses, and then upon a request for information, providing a delivery address corresponding to an objective to delivering a package to the address while the recipient is at that address. For example, this may be used to determine whether a package should be sent to a work address or a home address.

Predicting a final destination may include calculating from delivery route data, an estimated delivery window. If potential destination addresses are known this may be done for each of the potential destinations as different destinations (e.g., business address vs. home address) may have different delivery routes and delivery windows.

Alternatively, such dynamic address capabilities may be implemented by a user supplying multiple address options along with a schedule (e.g., days or time windows when they are preferred).

In another variation, the last leg of delivery may enable collection of a user information. This variation may involve dynamically communicating with a recipient based on the user information code. Such a variation may include, in response to processing a user information code at a parcel processing site, sending a communication requesting user input on delivery information, receiving user input and applying that received information in setting final delivery information. In this variation, the recipient may receive a communication on the day of parcel delivery asking for final delivery address information for a select time window. The parcel can be automatically sorted for final delivery based on the provided user input.

As an alternative user input, location information detected by a client device of the recipient may be used in selecting one of a set of addresses, where the address is selected based on expected delivery time and location of the recipient. Setting the final delivery information may involve printing a label with a final address but may alternatively or additionally include updating a data system with the final address information. If a new label is not used, then a delivery person may be notified of where to deliver the package through a digital system. For example, the delivery person may be directed to deliver package with printed label “AP6-LW3” to house at “123 A Street.”

As another exemplary application of the method, user information codes may be used within an application instance such that user information may be used within external applications without necessarily exposing personal information through the human-visible user interface. For example, a delivery service (e.g., a taxi service or package delivery service) may enable user information codes to be entered in place of actual address information. The code may then be translated into an address and used internally for providing navigation instructions to a driver. However, the actual address may never need to be exposed to the user of the delivery service app.

### 4. System Architecture

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

In one variation, a system comprising of one or more computer-readable mediums (e.g., a non-transitory computer readable mediums) storing instructions that, when executed by the one or more computer processors, cause a computing platform to perform operations comprising those of the system or method described herein such as: generating a user information code and updating a user information system recording an association between the user information code and user information, establishing an association of a user information code with a delivery order, and servicing information requests that include the user information code.

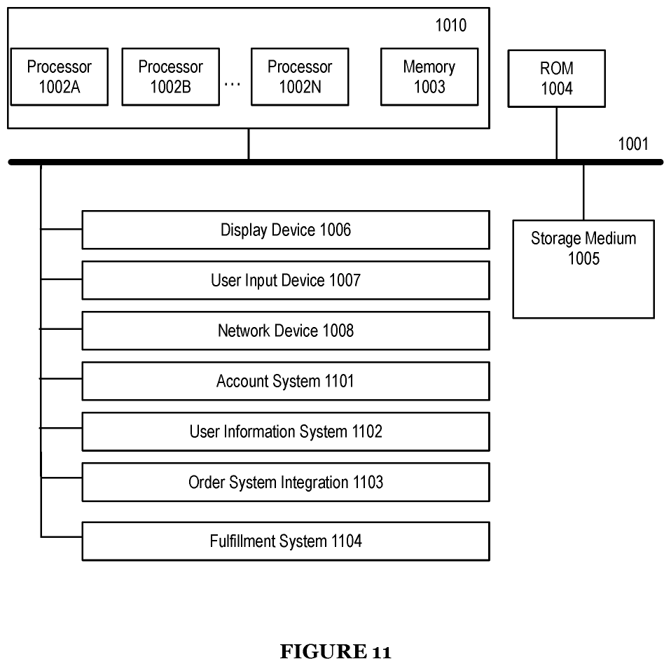

FIG. 11 is an exemplary computer architecture diagram of one implementation of the system. In some implementations, the system is implemented in a plurality of devices in communication over a communication channel and/or network. In some implementations, the elements of the system are implemented in separate computing devices. In some implementations, two or more of the system elements are implemented in same devices. The system and portions of the system may be integrated into a computing device or system that can serve as or within the system.

The communication channel 1001 interfaces with the processors 1002A-1002N, the memory (e.g., a random access memory (RAM)) 1003, a read only memory (ROM) 1004, a processor-readable storage medium 1005, a display device 1006, a user input device 1007, and a network device 1008. As shown, the computer infrastructure may be used in connecting an account system 1101, user information system 1102, order system integration 1103, fulfillment system 1104, and/or other suitable computing devices.

The processors 1002A-1002N may take many forms, such CPUs (Central Processing Units), GPUs (Graphical Processing Units), microprocessors, ML/DL (Machine Learning/Deep Learning) processing units such as a Tensor Processing Unit, FPGA (Field Programmable Gate Arrays, custom processors, and/or any suitable type of processor.

The processors 1002A-1002N and the main memory 1003 (or some sub-combination) can form a processing unit 1010. In some embodiments, the processing unit includes one or more processors communicatively coupled to one or more of a RAM, ROM, and machine-readable storage medium; the one or more processors of the processing unit receive instructions stored by the one or more of a RAM, ROM, and machine-readable storage medium via a bus; and the one or more processors execute the received instructions. In some embodiments, the processing unit is an ASIC (Application-Specific Integrated Circuit). In some embodiments, the processing unit is a SoC (System-on-Chip). In some embodiments, the processing unit includes one or more of the elements of the system.

A network device 1008 may provide one or more wired or wireless interfaces for exchanging data and commands between the system and/or other devices, such as devices of external systems. Such wired and wireless interfaces include, for example, a universal serial bus (USB) interface, Bluetooth interface, Wi-Fi interface, Ethernet interface, near field communication (NFC) interface, and the like.

Computer and/or Machine-readable executable instructions comprising of configuration for software programs (such as an operating system, application programs, and device drivers) can be stored in the memory 1003 from the processor-readable storage medium 1005, the ROM 1004 or any other data storage system.

When executed by one or more computer processors, the respective machine-executable instructions may be accessed by at least one of processors 1002A-1002N (of a processing unit 1010) via the communication channel 1001, and then executed by at least one of processors 1001A-1001N. Data, databases, data records or other stored forms data created or used by the software programs can also be stored in the memory 1003, and such data is accessed by at least one of processors 1002A-1002N during execution of the machine-executable instructions of the software programs.

The processor-readable storage medium 1005 is one of (or a combination of two or more of) a hard drive, a flash drive, a DVD, a CD, an optical disk, a floppy disk, a flash storage, a solid-state drive, a ROM, an EEPROM, an electronic circuit, a semiconductor memory device, and the like. The processor-readable storage medium 1005 can include an operating system, software programs, device drivers, and/or other suitable sub-systems or software.

As used herein, first, second, third, etc. are used to characterize and distinguish various elements, components, regions, layers and/or sections. These elements, components, regions, layers and/or sections should not be limited by these terms. Use of numerical terms may be used to distinguish one element, component, region, layer and/or section from another element, component, region, layer and/or section. Use of such numerical terms does not imply a sequence or order unless clearly indicated by the context. Such numerical references may be used interchangeable without departing from the teaching of the embodiments and variations herein.

As a person skilled in the art will recognize from the previous detailed description and from the figures and claims, modifications and changes can be made to the embodiments of the invention without departing from the scope of this invention as defined in the following claims.

We claim:

1. A method comprising:
at a user interface of an application of a recipient, recording an association between user information and a user information code, the user information including at least shipping address information;
at an online marketplace, establishing an association of a user information code with a delivery order, the user information code used in place of a delivery address; and
servicing an information request that includes the user information code, the servicing the information request comprising generating a packing label of a product using the shipping address information accessed with the user information code.

2. The method of claim 1, wherein, when recording the association between the user information and the user information code, registering a client computing device configured with a location service; and wherein the servicing the information request further comprises:
during automated package processing of a delivery stage, detecting the user information code and requesting address information in the information request;
at the client computing device detecting location relative to the time of the information request,
selecting the shipping address information from a set of delivery address options based on the location, and
transmitting the shipping address information in response to the information request.

3. The method of claim 1, wherein the information request comprises account credentials of a requesting account; and wherein the servicing the information request further comprises authenticating the request based on access permissions of the account credentials and the user information code.

4. The method of claim 1, wherein the servicing the information request further comprises:
at a shipment processing system, automatically detecting a user information code on a package and initiating the information request,
at a database system, retrieving shipping address information associated with the user information code, and sending a response to the information request including the shipping address information,
wherein generating a packing label of a product using the shipping address information, comprises printing and applying the shipping address information to the package.

5. The method of claim 1, wherein establishing the association of the user information code with the delivery order comprises: receiving entry of the user information code in user input field, the user information code received in place of address information.

6. The method of claim 1, wherein establishing the association of the user information code with the delivery order comprises: receiving a communication address of a recipient; if the communication address is not associated with a recorded user information code that includes desired user information, transmitting a communication to the communication address with a link to a user interface for creating user information code record with the desired user information.

7. The method of claim 1, wherein establishing the association of the user information code with the delivery order comprises: receiving a set of communication addresses for a set of recipients; for each of the set of communication address:
if a given communication address is associated with a corresponding recorded user information code with shipping address information, processing an order instance using the corresponding recorded user information code;
if the given communication address is not associated with a corresponding recorded user information code with shipping address information, transmitting a communication to the communication address with a link to a user interface for creating user information code record with the desired user information.
if the given communication address is not associated with a recorded user information code that includes desired user-information, transmitting a communication to the communication address with a link to a user interface for creating user information code record with the desired user information.

8. A non-transitory computer-readable medium storing instructions that, when executed by one or more computer processors of a computing platform, cause the computing platform to:
at a user interface of an application of a recipient, recording an association between user information and a user information code, the user information including at least shipping address information;
at an online marketplace, establishing an association of a user information code with a delivery order, the user information code used in place of a delivery address; and
servicing an information request that includes the user information code, the servicing the information request comprising generating a packing label of a product using the shipping address information accessed with the user information code.

9. The non-transitory computer-readable medium of claim 8, wherein, when recording the association between the user information and the user information code, registering a client computing device configured with a location service; and wherein the servicing the information request further comprises:
during automated package processing of a delivery stage, detecting the user information code and requesting address information in the information request;
at the client computing device detecting location relative to the time of the information request,
selecting the shipping address information from a set of delivery address options based on the location, and
transmitting the shipping address information in response to the information request.

10. The non-transitory computer-readable medium of claim 8, wherein the information request comprises account credentials of a requesting account; and wherein the servicing the information request further comprises authenticating the request based on access permissions of the account credentials and the user information code.

11. The non-transitory computer-readable medium of claim 8, wherein the servicing the information request further comprises:
at a shipment processing system, automatically detecting a user information code on a package and initiating the information request,
at a database system, retrieving shipping address information associated with the user information code, and sending a response to the information request including the shipping address information,
wherein generating a packing label of a product using the shipping address information, comprises printing and applying the shipping address information to the package.

12. The non-transitory computer-readable medium of claim 8, wherein establishing the association of the user information code with the delivery order comprises: receiving entry of the user information code in user input field, the user information code received in place of address information.

13. The non-transitory computer-readable medium of claim 8, wherein establishing the association of the user information code with the delivery order comprises: receiving a communication address of a recipient; if the communication address is not associated with a recorded user information code that includes desired user information, transmitting a communication to the communication address with a link to a user interface for creating user information code record with the desired user information.

14. The non-transitory computer-readable medium of claim 8, wherein establishing the association of the user information code with the delivery order comprises: receiving a set of communication addresses for a set of recipients; for each of the set of communication address:
if a given communication address is associated with a corresponding recorded user information code with shipping address information, processing an order instance using the corresponding recorded user information code;
if the given communication address is not associated with a corresponding recorded user information code with shipping address information, transmitting a communication to the communication address with a link to a user interface for creating user information code record with the desired user information.
if the given communication address is not associated with a recorded user information code that includes desired user-information, transmitting a communication to the communication address with a link to a user interface for creating user information code record with the desired user information.

15. A system comprising of:
one or more computer-readable mediums storing instructions that, when executed by the one or more computer processors, cause a computing platform to perform operations comprising:
at a user interface of an application of a recipient, recording an association between user information and a user information code, the user information including at least shipping address information;
at an online marketplace, establishing an association of a user information code with a delivery order, the user information code used in place of a delivery address; and
servicing an information request that includes the user information code, the servicing the information request comprising generating a packing label of a product using the shipping address information accessed with the user information code.

16. The system of claim 15, wherein, when recording the association between the user information and the user information code, registering a client computing device configured with a location service; and wherein the servicing the information request further comprises:
during automated package processing of a delivery stage, detecting the user information code and requesting address information in the information request;
at the client computing device detecting location relative to the time of the information request,
selecting the shipping address information from a set of delivery address options based on the location, and
transmitting the shipping address information in response to the information request.

17. The system of claim 15, wherein the information request comprises account credentials of a requesting account; and wherein the servicing the information request further comprises authenticating the request based on access permissions of the account credentials and the user information code.

18. The system of claim 15, wherein the servicing the information request further comprises:
at a shipment processing system, automatically detecting a user information code on a package and initiating the information request,
at a database system, retrieving shipping address information associated with the user information code, and sending a response to the information request including the shipping address information,
wherein generating a packing label of a product using the shipping address information, comprises printing and applying the shipping address information to the package.

19. The system of claim 15, wherein establishing the association of the user information code with the delivery order comprises: receiving entry of the user information code in user input field, the user information code received in place of address information.

20. The system of claim 15, wherein establishing the association of the user information code with the delivery order comprises: receiving a communication address of a recipient; if the communication address is not associated with a recorded user information code that includes desired user information, transmitting a communication to the communication address with a link to a user interface for creating user information code record with the desired user information.
